(19) United States
(12) Patent Application Publication
(10) Pub. No.: US 2024/0156568 A1
(43) Pub. Date: May 16, 2024

(54) BITE-SAFE DENTAL CARE APPARATUS

(71) Applicant: MICHAEL JAY PERRY, ALBANY, OR (US)

(72) Inventor: MICHAEL JAY PERRY, ALBANY, OR (US)

(21) Appl. No.: 18/485,154

(22) Filed: Oct. 11, 2023

Related U.S. Application Data
(60) Provisional application No. 63/415,179, filed on Oct. 11, 2022.

(51) Int. Cl. A61C 5/90

(52) U.S. Cl. CPC A61C 5/90; A61C 2203/00

(57) ABSTRACT

Apparatuses, systems, and methods are disclosed for a bite-safe dental care apparatus. The apparatus includes a three-dimensional body. The three-dimensional body is comprised of a substantially robust and flexible material. The apparatus includes at least one protruding member extending from the three-dimensional body. The at least one protruding member is configured to act as a bite block when inserted into a user's mouth. A width of the at least one protruding member is different than a thickness of the at least one protruding member such that the at least one protruding member props the user's mouth open at different positions when used as a bite block.

### CROSS-REFERENCE TO RELATED APPLICATION

This application claims the benefit of U.S. Provisional Patent Application No. 63/415,179, entitled “BABY AND TODDLER SAFE BITE BLOCK” and filed on Oct. 11, 2022, for Michael Jay Perry, which is incorporated herein by reference.

### FIELD

This disclosure relates generally to dental care systems and apparatuses, and more particularly to bite-safe dental care apparatuses.

### BACKGROUND

Small dental devices, such as bite blocks, may be placed in the mouth to keep the upper and lower teeth apparat during certain dental tasks and procedures. Such devices can help to keep the upper and lower teeth sufficiently displaced to allow a caregiver to administer dental care, such as routine flossing and brushing, teeth cleanings, cavity fillings, or other procedures.

### SUMMARY

The subject matter of the present application has been developed in response to the present state of the art, and in particular, in response to the shortcomings of bite-safe dental care apparatuses, that have not yet been fully solved by currently available techniques. Accordingly, the subject matter of the present application has been developed to provide bite-safe dental care apparatuses that overcome at least some of the above-discussed shortcomings of prior art techniques.

The following is a non-exhaustive list of examples, which may or may not be claimed, of the subject matter, disclosed herein.

The following portion of this paragraph delineates example 1 of the subject matter, disclosed herein. According to example 1, an apparatus includes a three-dimensional body and at least one protruding member. The three-dimensional body is comprised of a substantially robust and flexible material. The at least one protruding member extends from the three-dimensional body. The at least one protruding member is configured to act as a bite block when inserted into a user's mouth. A width of the at least one protruding member is different than a thickness of the at least one protruding member such that the protruding member props the user's mouth open at different positions when used as a bite block.

The following portion of this paragraph delineates example 2 of the subject matter, disclosed herein. According to example 2, which encompasses example 1, above, the at least one protruding member is configured to extend at least partially into the user's mouth when the first surface contacts an exterior of the user's mouth. The at least one protruding member includes a second surface extending from the first surface at an angle not greater than 90 degrees.

The following portion of this paragraph delineates example 3 of the subject matter, disclosed herein. According to example 3, which encompasses example 1 or 2, above, the second surface is configured to contact an interior of the user's cheek when the first surface contacts the exterior.

The following portion of this paragraph delineates example 4 of the subject matter, disclosed herein. According to example 4, which encompasses any one of examples 1-3, above, the at least one protruding member has a minimum dimension of not greater than 5 centimeters and has a maximum dimension different from the minimum dimension.

The following portion of this paragraph delineates example 5 of the subject matter, disclosed herein. According to example 5, which encompasses any one of examples 1-4, above, the maximum dimension is not less than 1.5 centimeters.

The following portion of this paragraph delineates example 6 of the subject matter, disclosed herein. According to example 6, which encompasses any one of examples 1-5, above, the apparatus includes an additional protruding member extending from the three-dimensional body. The additional protruding member is configured to act as a bite block when inserted into the user's mouth and is at least partially curved or bent. The additional protruding member has at least one of: a minimum dimension different from the minimum dimension of the at least one protruding member and not greater than 5 centimeters and a maximum dimension different from the maximum dimension of the at least one protruding member.

The following portion of this paragraph delineates example 7 of the subject matter, disclosed herein. According to example 7, which encompasses any one of examples 1-6, above, at least one of the three-dimensional body or the at least one protruding member includes one or more surface protrusions.

The following portion of this paragraph delineates example 8 of the subject matter, disclosed herein. According to example 8, which encompasses any one of examples 1-7, above, the material has a Shore A hardness of not greater than 80.

The following portion of this paragraph delineates example 9 of the subject matter, disclosed herein. According to example 9, which encompasses any one of examples 1-8, above, the apparatus is shaped to visually resemble an animal or a person and the at least one protruding member is shaped to resemble an appendage of the animal or person.

The following portion of this paragraph delineates example 10 of the subject matter, disclosed herein. According to example 10, which encompasses any one of examples 1-9, above, the three-dimensional body includes an aperture useable for gripping the apparatus and having a width greater than or equal to 1 centimeter.

The following portion of this paragraph delineates example 11 of the subject matter, disclosed herein. According to example 11, which encompasses any one of examples 1-10, above, a surface area of the three-dimensional body is greater than a surface area of the at least one protruding member. The three-dimensional body has a thickness that is less than the maximum dimension of the at least one protruding member.

The following portion of this paragraph delineates example 12 of the subject matter, disclosed herein. According to example 12, which encompasses any one of examples 1-11, above, the at least one protruding member is made of the material. The material is configured to maintain its shape in response to exposure to a pressure level of up to at least three pounds per square inch and/or in response to exposure to a temperature of up to at least 50 degrees Celsius.

The following portion of this paragraph delineates example 13 of the subject matter, disclosed herein. According to example 13, which encompasses any one of examples 1-12, above, the material is configured not to permanently deform or fracture in response to exposure to a temperature of 100 degrees Celsius.

The following portion of this paragraph delineates example 14 of the subject matter, disclosed herein. According to example 14, which encompasses any one of examples 1-13, above, the material includes at least one of the following: silicone, rubber, polyethylene, polypropylene, or any combination thereof.

The following portion of this paragraph delineates example 15 of the subject matter, disclosed herein. According to example 15, which encompasses any one of examples 1-14, above, the material includes food-grade silicone.

The following portion of this paragraph delineates example 16 of the subject matter, disclosed herein. According to example 16, which encompasses any one of examples 1-15, above, the three-dimensional body further includes a channel configured to receive at least a portion of a finger of the user or an additional user. The channel does not intersect or extend into the portion.

The following portion of this paragraph delineates example 17 of the subject matter, disclosed herein. According to example 17, a system includes a three-dimensional body, the three-dimensional body comprised of a substantially robust and flexible material. The system includes at least one protruding member extending from the three-dimensional body, the at least one protruding member configured to act as a bite block when inserted into a user's mouth. A width of the at least one protruding member is different than a thickness of the at least one protruding member such that the protruding member props the user's mouth open at different positions when used as a bite block. The system includes an electronic component disposed within the portion and configured to cause the portion to vibrate.

The following portion of this paragraph delineates example 18 of the subject matter, disclosed herein. According to example 18, which encompasses example 17, above, the system includes one or more light sources disposed within at least one of the body and the at least one protruding member.

The following portion of this paragraph delineates example 19 of the subject matter, disclosed herein. According to example 19, which encompasses any of examples 17-18, above, the three-dimensional body further includes a switch configured to control the electronic component.

The following portion of this paragraph delineates example 20 of the subject matter, disclosed herein. The method includes forming a three-dimensional body comprised of a substantially robust and flexible material. The method includes forming at least one protruding member extending from the three-dimensional body and configured to act as a bite block when inserted into a user's mouth. The width of the at least one protruding member is different than a thickness of the at least one protruding member such that the at least one protruding member props the user's mouth open at different positions when used as a bite block.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1A is a front view a bite-safe dental care apparatus, according to one or more examples of the present disclosure;

FIG. 1B is a rear view of a bite-safe dental care apparatus, according to one or more examples of the present disclosure;

FIG. 1C is a top view of a bite-safe dental care apparatus, according to one or more examples of the present disclosure;

FIG. 1D illustrates a bite-safe dental care apparatus being partially inserted into a user's mouth in a substantially horizontal orientation, according to one or more examples of the present disclosure;

FIG. 1E illustrates a close-up view of a bite-safe dental care apparatus being partially inserted into a user's mouth in a substantially horizontal orientation, according to one or more examples of the present disclosure;

FIG. 1F illustrates a bite-safe dental care apparatus being partially inserted into a user's mouth at an angle, according to one or more examples of the present disclosure;

FIG. 1G illustrates a bite-safe dental care apparatus being partially inserted into a user's mouth in a substantially vertical orientation, according to one or more examples of the present disclosure;

FIG. 2 illustrates a bite-safe dental care apparatus having differently textured bite blocks, according to one or more examples of the present disclosure;

FIG. 3 illustrates a bite-safe dental care apparatus having a bite block and configured to be attached to a tether, according to one or more examples of the present disclosure;

FIG. 4 illustrates a bite-safe dental care apparatus having a channel to receive a finger, according to one or more examples of the present disclosure;

FIG. 5 illustrates a system for bite-safe dental care, according to one or more examples of the present disclosure; and

FIG. 6 is a schematic flow chart of a method of making a bite-safe dental care apparatus, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Proper dental care helps to ensure dental health and longevity. Certain activities related to dental care, such as routine flossing and brushing, teeth cleanings, cavity fillings, or other dental procedures, are best performed with the patient's mouth at least slightly open. A caregiver may have difficulty administering dental care to patients or children who struggle to keep their mouth open for an extended period of time or to resist the urge to bite down on a tool being used for the dental care, such as a toothbrush. Such care can be particularly difficult to administer to young children, for example. Young children may also experience discomfort or pain as new teeth emerge. Chewing or biting down on particular surfaces can help to relieve this pain and discomfort.

Examples of the present disclosure include systems and apparatuses that help to keep the top teeth of the mouth displaced from the bottom teeth of the mouth. In some examples, these systems and apparatuses also help to entertain and/or relieve pain and discomfort.

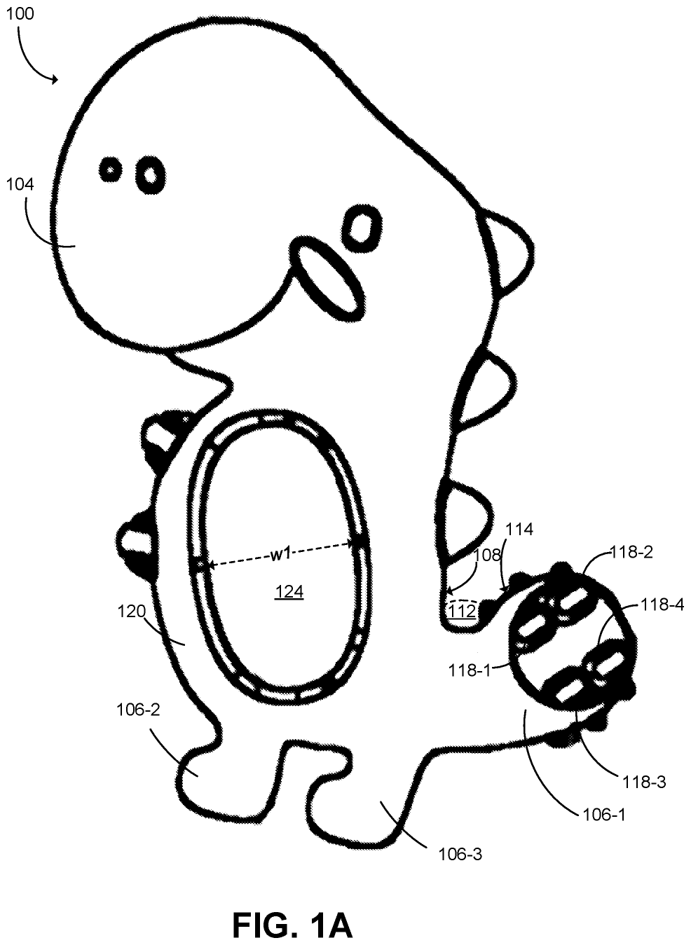

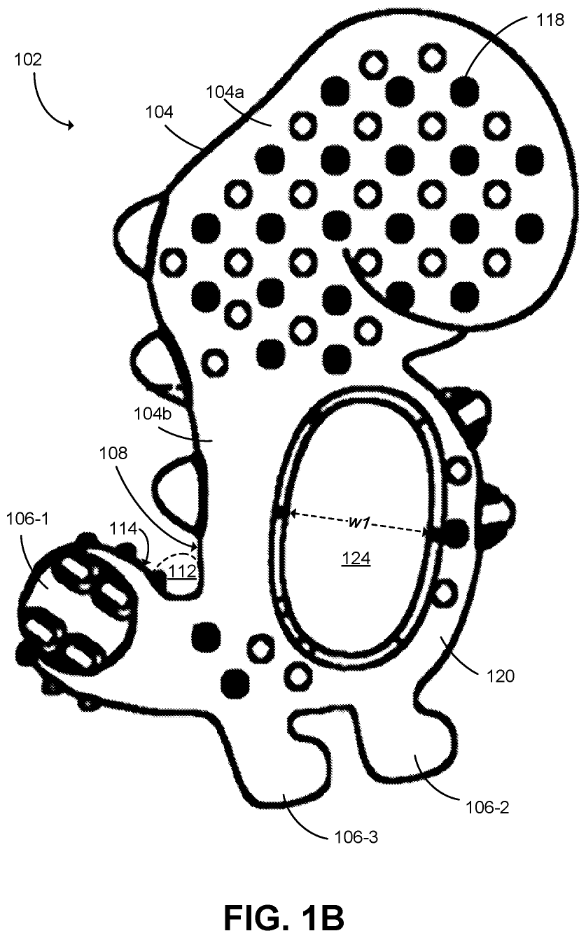

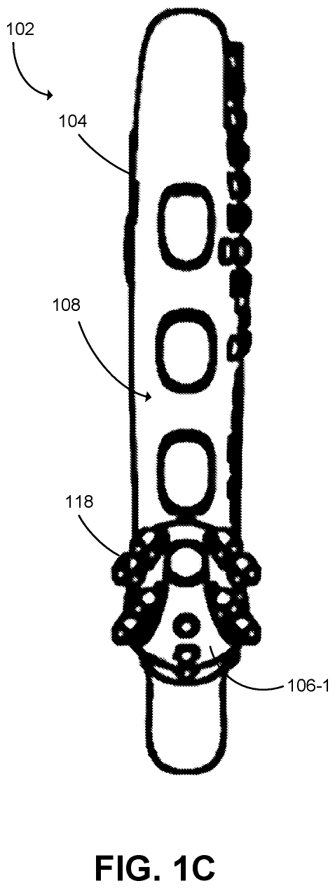

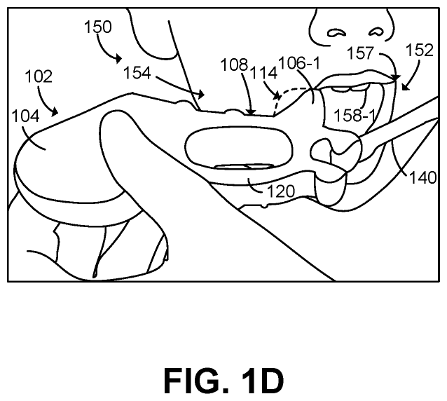

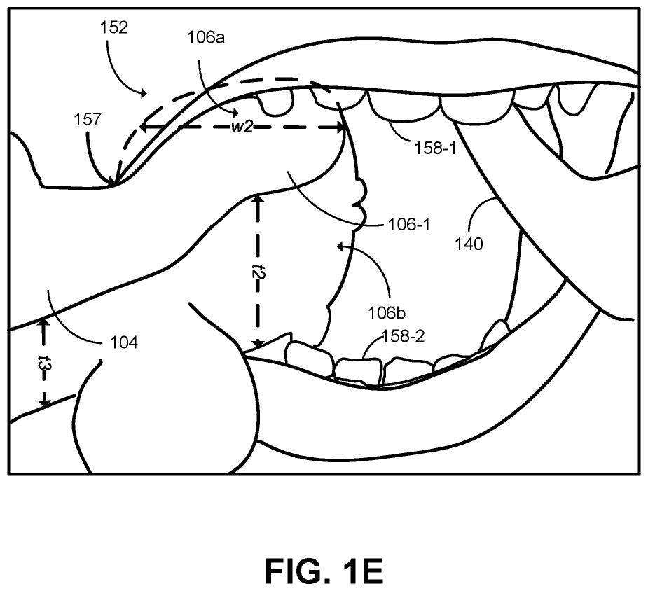

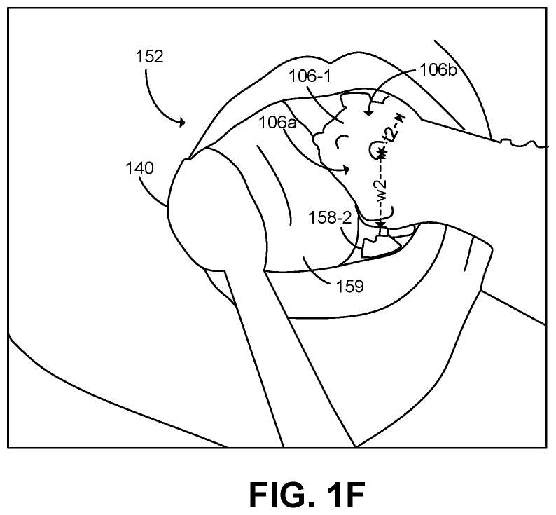

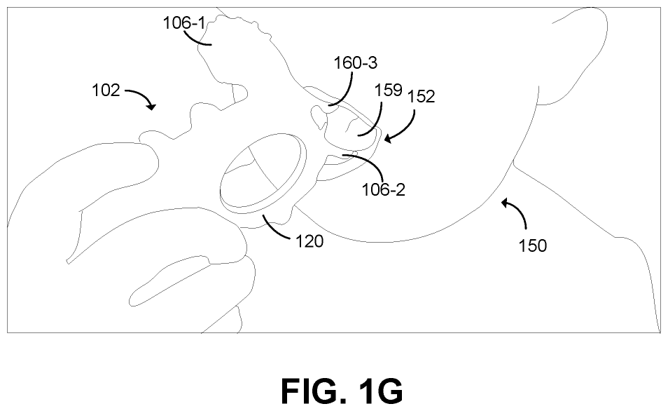

As shown in FIGS. 1A-G, examples of the present disclosure include a dental care apparatus 102. In some examples, the apparatus 102 helps to keep a mouth 152 of a patient 150 at least slightly open during performance of dental care. For example, as shown in FIG. 1D the apparatus 102 is partially inserted into a patient's 150 mouth 152 while a caregiver is brushing a child's teeth 158 (e.g., with a toothbrush 140).

As used herein, the term “patient” includes any person or animal with the apparatus 102 at least partially inserted in their mouth. For example, a “patient” includes a person, a child, an infant, an elderly person, a disabled person, a patient visiting a dentist, a domesticated animal (e.g., dog, cat, horse, or rodent), or any combination thereof. As used herein, the term “caregiver” includes any person administering dental care to the patient using the apparatus 102 or holding the apparatus 102 in place while another administers the dental care to the patient. A caregiver includes, for example, a parent, guardian, caretaker, nurse, pet owner, dentist, dental hygienist, orthodontist, periodontist, surgeon, or any combination thereof.

As used herein, the term “dental care” includes any task or procedure relating to improvement of and/or maintenance of oral and/or dental health. For example, the apparatus 102 can facilitate teeth brushing, teeth flossing, teeth examination, dental procedures, dental surgeries, teeth cleanings, gum treatments, orthodontic services, or any combination thereof. Although the present disclosure describes use of the apparatus 102 to help keep a user's mouth open for dental care, those of skill in the art will appreciate other possible uses for the apparatus 102, such as for entertainment, administering medication, or relieving discomfort.

In some examples, in addition to helping to maintain distance between a patient's 150 top teeth 158-1 and bottom teeth 158-2 (and/or top gums and bottom gums), the apparatus 102 serves as a teething toy or other form of entertainment. As shown in FIG. 1B, for example, in some embodiments, the apparatus 102 includes surfaces with texture and/or protrusions 118 to help promote pain relief and/or oral exploration. In some examples, the dimensions of the apparatus 102 are sufficient to prevent choking on the apparatus 102. Additionally, the apparatus 102, at least in some examples, is made of a material that is robust, flexible, and safe for oral exposure.

In some examples, the apparatus 102 includes a body 104 that is three-dimensional and includes one or more protruding members 106-1, 106-2 (referred to herein, individually or collectively, as “protruding member 106”) extending from the body 104. In some examples, the protruding members 106-1, 106-2 extend laterally outward from the body 104. In some examples, the protruding members 106 are portions of the apparatus 102 that are configured to extend into a user's 150 mouth 152 while the body 104 remains exterior to the mouth 152.

In some examples, the protruding member 106 is configured to act as a bite block when inserted into the user's 150 mouth 152. In some examples, the protruding member 106 is configured to maintain distance between a patient's 150 top teeth 158-1 and bottom teeth 158-2 (and/or top gums and bottom gums). For example, as shown in FIGS. 1D and 1E, the protruding member 106 keeps the top teeth 158-1 and the bottom teeth 158-2 sufficiently separated to allow a caregiver to insert a toothbrush 140 into the mouth 152. In some examples, the protruding member 106 includes a passage and/or is sufficiently hollow such that a tool, such as a toothbrush 140, may be inserted through the protruding member 106 to access the user's 150 mouth 152.

In some examples, a width w2 of the protruding member 106 is different than a thickness t2 of the protruding member. As such, the protruding member 106 props the user's 150 mouth 152 open at different positions when used as a bite block. For example, as shown in FIG. 1E, when the apparatus 102 is positioned in a substantially horizontal configuration and the teeth 158 contact the protruding member 106 on a surface 106a defined by the width w2, the distance between the top teeth 158-1 and the bottom teeth 158-2 is different than when the apparatus 102 is angled differently, as shown in FIG. 1F. In some examples, the thickness t2 is approximately 2 centimeters.

In some examples, the protrusion 106 has dimensions that are sufficiently small to allow insertion into the mouth of an infant and/or a young child. In some examples, the protrusion 106 has a minimum dimension of not greater than 5 centimeters. For example, as shown in FIG. 1E, the protrusion 106-1 has a thickness t2 that is less than its width w2. In some examples, the thickness t2 is not greater than 5 centimeters. As such, the protrusion 106-1 can be inserted into a mouth 152 of a small child, at least in one orientation. In other examples, the apparatus 102 is used to prop open a mouth of a larger person and/or an animal, and the protrusion 106 has a minimum dimension that is greater than 5 centimeters.

In some examples, the protruding member 106 has dimensions that are sufficiently large to prop open a mouth of a user 150 with a large enough gap between top teeth 158-1 and bottom teeth 158-2 to allow for insertion of a finger or a small tool (e.g., a toothbrush 140) into the mouth 152. In some examples, the protrusion 106 has a maximum dimension that is different from the minimum dimension. As used herein, a “maximum dimension” refers to a measurable extent (e.g., length or width) of a side or surface of the protruding member that is greater than any other measurable extent of that side or surface or any other side or surface of that protruding member. As used herein, a “minimum dimension” refers to a measurable extent (e.g., length or width) of a side or surface of the protruding member that is less than any other measurable extent of that side or surface or any other side or surface of that protruding member.

For example, as shown in FIG. 1E, a protrusion has a maximum dimension along a width w2 that is greater than a minimum dimension, which is along its thickness t2. In some examples, the maximum dimension is not less than 1.5 centimeters. In some examples, the maximum dimension is not greater than 10 centimeters.

In some examples, the body 104 includes a first surface 108. The first surface 108 is configured to contact an exterior 154 of a user's 150 mouth, e.g., a cheek. In some examples, a protruding member 106 is configured to extend at least partially into the mouth 152 when the first surface 108 contacts the exterior 154 of the user's 150 mouth. In some examples, the protruding member 106 includes a second surface 114. For example, as shown in FIG. 1A, the second surface 114 is an outer surface of the protruding member 106, which is shaped to visually represent a dinosaur tail. In some examples, the second surface 114 is configured to contact an interior of the user's 150 cheek (e.g., the surface of the cheek opposite to the cheek's exterior 154) when the first surface 108 contacts the exterior 154.

In some examples, the second surface 114 connects to and extends from the first surface 108 at an angle 112. In some examples, the angle 112 is an angle of the protrusion 106 with respect to the body 104. In some examples, the angle 112 is not greater than 90 degrees. In some examples, the angle 112 is such that the first surface 108 and the second surface 114 wrap together around an edge 157 of the user's 150 mouth 152 when the edge 157 is between the first surface 108 and the second surface 114. For example, as shown in FIG. 1E, the body 104 and protruding member 106 together hook around the edge 157.

As shown in FIGS. 1A-1F, in some examples, the apparatus 102 is shaped to resemble a character, such as a person, animal, and/or mythical creature. In such examples, the body 104 is shaped to resemble the body and/or torso of such a character. For example, as shown in FIG. 1A, the apparatus 102 is shaped to resemble a dinosaur on a small scale. The body 104 is shaped to at least substantially resemble the torso 104a and head 104b of a dinosaur. In another example, the apparatus 102 is shaped to resemble a dog, and the body 104 is shaped to resemble a torso of the dog. In some examples, the proportions of various parts of the apparatus 102 are not to scale. For example, as shown in FIG. 1A, the body 104 includes a head portion 104a that is larger than the torso portion 104b.

In some examples, the apparatus 102 includes protruding members 106 of different dimensions. For example, as shown in FIG. 1A, the apparatus 102 includes a first protruding member 106-1 and two additional protruding members 106-2 and 106-3 that are each smaller in surface area than the first protruding member 106. In some examples, the additional protruding members 106-2 and 106-3 are positioned proximate to each other. For example, as shown in FIG. 1A, the first protruding member 106-1 visually resembles a larger tail of an animal, and the additional protruding members 106-2 and 106-3 visually resemble legs of the animal.

In some examples, the additional protruding members 106-2 and 106-3 are also configured to act as a bite block when inserted into the user's 150 mouth 152, either together or separately. In some examples, the additional protruding members 106-2 and 106-3 are configured to be inserted into the mouth 152 on opposite sides of the user's 150 tongue 159. For example, as shown in FIG. 1G, when the apparatus 102 is oriented in a substantially perpendicular to a user's 150 face and mouth 152, the additional protruding members 106-2 and 106-3 work together to prop open the mouth 152, with one member 106-3 extending over the tongue 159 and another member 106-2 extending under the tongue 159. Although not shown in FIG. 1G, in some examples, the member 106-3 contacts the top teeth, and the member 106-2 contacts the bottom teeth 158-2. In some examples, the additional protruding members 106-2 and 106-3 are configured to create a gap between the user's 150 gums that is different (e.g., less than the gap created by any other protruding member 106-1 when inserted into the mouth 152).

In some examples, the apparatus 102 is made of a material that is suitable for insertion into a mouth 152. In some examples, the apparatus 102 and/or the body 104 is comprised of a substantially robust and flexible material. For example, the apparatus 102 is made of a material that is at least slightly flexible, yet of sufficient tensile strength to not permanently fracture or deform in response to a pressure exerted by a user 150 biting down on the apparatus 102. For example, the apparatus 102 is made of a material to withstand a pressure level of up to at least three pounds per square inch (“psi”) or more. In some examples, the apparatus 102 is made of material to withstand a bite force of 200 psi or more. In some examples, the apparatus 102, or at least the protruding members 106 are made of a material with sufficient strength to maintain separation of the mouth 152 when the user 150 bites down on the protruding member(s) 106. In some examples, the material is also slightly malleable. For example, when the user 150 bites down on the apparatus 102, the material gives at least slightly. In some examples, the material is configured to yield to allow a user 150 to create an indentation of up to two centimeters when a bite force of not less than 3 and not greater than 200 psi is applied.

In some examples, the apparatus 102 is made of a material having a Shore A hardness of not greater than 80. In some examples, the apparatus 102 is made of a material having a Shore A hardness of not less than 30 and not greater than 90. As used herein, “Shore A hardness” refers to a measure of the material's resistance to indentation that would be familiar to one of skill in the art. In some examples, the material includes child-safe polymers. In some examples, the material includes at least one of the following: silicone, rubber, polyethylene, polypropylene, or any combination thereof. In some examples, the material includes food-grade polymers, such as food-grade silicone. In some examples, the material includes hospital-grade silicone. In some examples, the apparatus 102 includes a harder material (e.g., wood) but is coated with a more flexible material (e.g., silicone).

In some examples, the apparatus 102 is made of a material to withstand temperatures to allow the apparatus 102 to be washed (e.g., in a dishwasher or using hot water), sanitized (e.g., in boiling water), and/or autoclaved. In some examples, the material does not permanently deform and/or fracture in response to exposure to a temperature of 50 degrees Celsius. In some examples, the material can withstand temperatures greater than or equal to 100 degrees Celsius and/or 130 degrees Celsius.

In some examples, the body 104 and the protruding members 106 are made of the same material. In other examples, the body 104 and the protruding members 106 are made of different materials.

In some examples, the apparatus 102 includes surfaces, textures, and/or materials to help ease discomfort related to teething and/or to help promote oral exploration in young children. In some examples, at least one of the body 104 and the one or more protruding members 106 include one or more surface protrusions 118. As shown in FIG. 1B, in some examples, the surface protrusions 118 are evenly spaced from each other. In some examples, the surface protrusions 118 are rounded. In some examples, the arrangement of the protrusions 118 forms a pattern and/or image. In some examples, the surface protrusions 118 are made of the same material as the body 104 and/or of the protruding members 106. In other embodiments, the surface protrusions 118 are made of a different material. In some examples, the surface protrusions 118 include, for example, bumps, ridges, indentations, or any combination thereof. In some examples, the surface protrusions 118 are shaped as half spheres, pyramids, rectangular prisms, half cylinders, or any combination thereof. In some examples, the protrusions 118 are made of the same material as the body 104 and/or the protruding member 106. In other examples, the protrusions 118 are made of a different material.

As shown in FIG. 1B, in some examples, at least one of the protruding members 106-1 includes surface protrusions (e.g., protrusions 118-1, . . . , 118-4) that are arranged to receive one or more teeth 158 between them when the protruding member 106-1 is inserted into the mouth 152. For example, the surface protrusions 118-1 and 118-2 are adjacent to each other and spaced apart from two other surface protrusions 118-3 and 118-4 such that one or more teeth 158 of a row of teeth 158 are received between the protrusions 118-1 and 118-2 and the protrusions 118-3 and 118-4. For example, the protruding member 106-1 is inserted near the back of the mouth 152 and receives a molar between the protrusions 118-1, 118-2 and 118-3, 118-4.

In some examples, the body 104 is larger than any of the protruding members 106 and has a surface area that is greater than an individual surface area of any one of the protruding members 106. In some examples, the body 104 is substantially planar and/or substantially flat, notwithstanding small protrusions 118. As shown in FIG. 1E, in some examples, the body 104 has a thickness t3 that is less than a thickness t2 of the protruding member 106-1. In some examples, the thickness t3 of the body 104 is not less than half of the thickness t2 of the protruding member 106-1.

In some examples, the body 104 is configured to be held by the patient 150 and/or the caregiver 160, externally to the mouth 152, while the dental care is administered. In some examples, the body 104 includes features that help a user 150, such as a patient 150 and/or caregiver 160, to hold the apparatus 102. As shown in FIG. 1A, in some examples, the body 104 includes an aperture 124 useable for gripping the apparatus 102. In some examples, the apparatus 102 includes a handle 120. In some examples, the aperture 124 has a width w1 that is sufficient to allow a user to grip the apparatus 102 via the aperture 124. In some examples, the width w1 is greater than or equal to one centimeter. In some examples, the width w1 is not greater than fifteen centimeters.

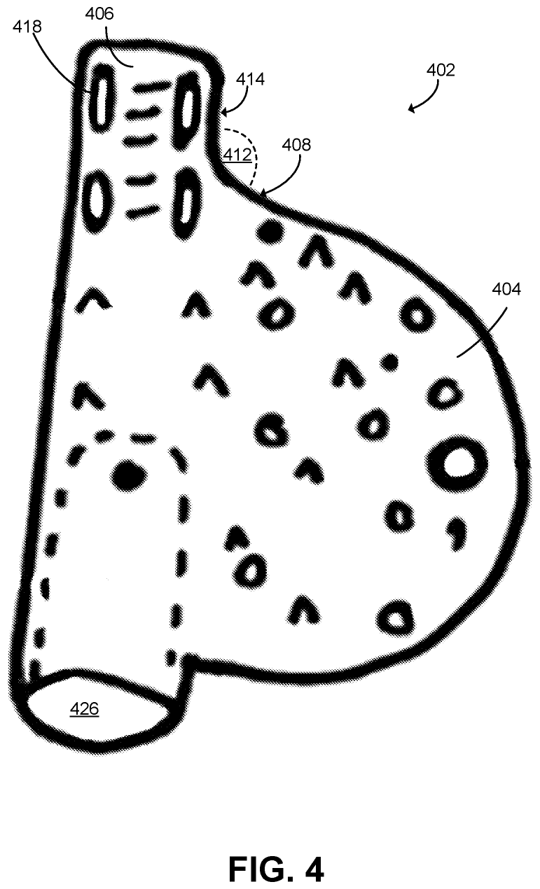

As shown in FIG. 4, in some examples, an apparatus 402 includes a channel 426. In some examples, the channel 426 is of dimensions sufficient to receive at least a portion of a finger of the user 150 and/or of an additional user. For example, the channel 426 is configured to receive a portion of an adult finger such that a caregiver may hold the apparatus 400 by inserting a portion of their finger into the channel 426. As shown in FIG. 4, in some examples, the channel 426 does not intersect or extend into the protruding member 406. As such, a caregiver may use the protruding member 406 as a bite block without injuring their finger. In some examples, the apparatus 402 includes a channel 426 but not any apertures through the body 404.

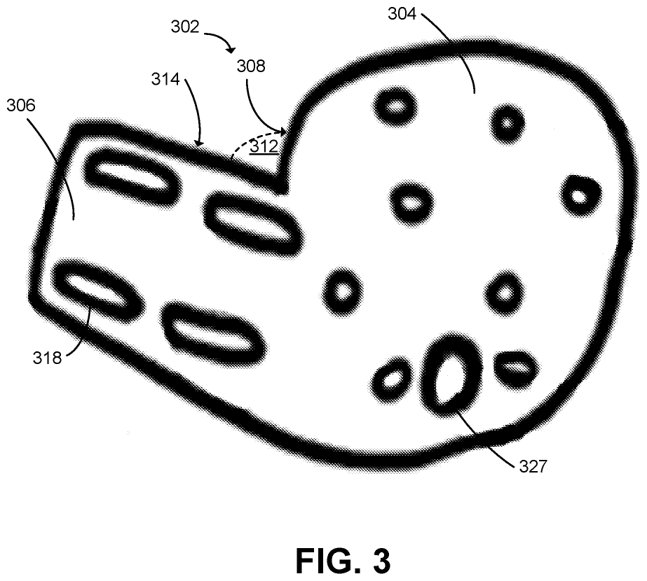

As shown in FIGS. 3 and 4, in some examples, a dental care apparatus 302 and/or 402 includes a tether aperture 327. In some examples, the width of the tether aperture 327 and/or 427 is less than an inch. In some examples, the tether aperture 327 extends through a thickness of the apparatus 302 such that a cord, rope, thread, tether, or the like, can be threaded through the tether aperture 327. In some examples, the body 304 is made of a flexible material such that the width of the tether aperture 327 is able to expand and/or retract and changes as an end of a tether is pushed through it.

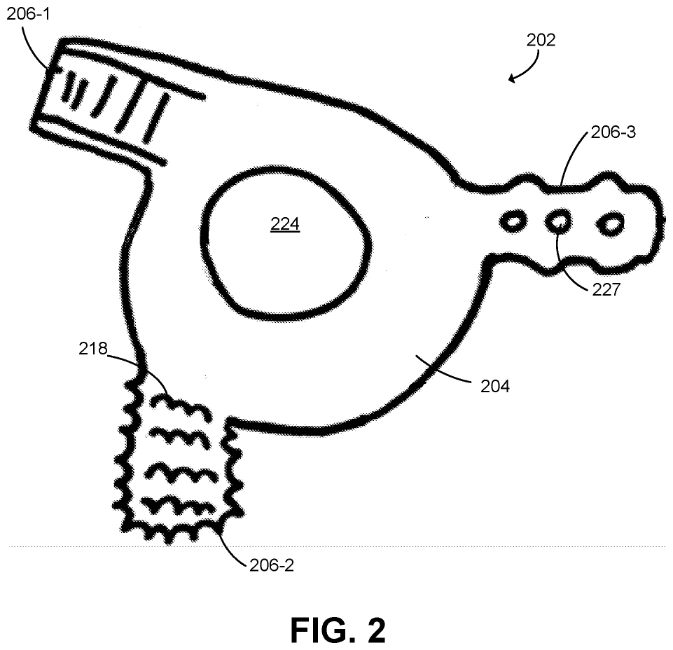

As shown in FIG. 2, in some examples, a dental care apparatus 202 includes a number of protruding members 206-1, . . . , 206-3 (“206”) of different textures and/or shapes of protrusions 218-1, . . . , 218-3. In some examples, the protruding members 206 are equally spaced from each other along a perimeter of the body 204 of the apparatus 202. The apparatus 202 also includes an aperture 224 for gripping the apparatus 202. In some examples, the aperture 224 is central to the body 204.

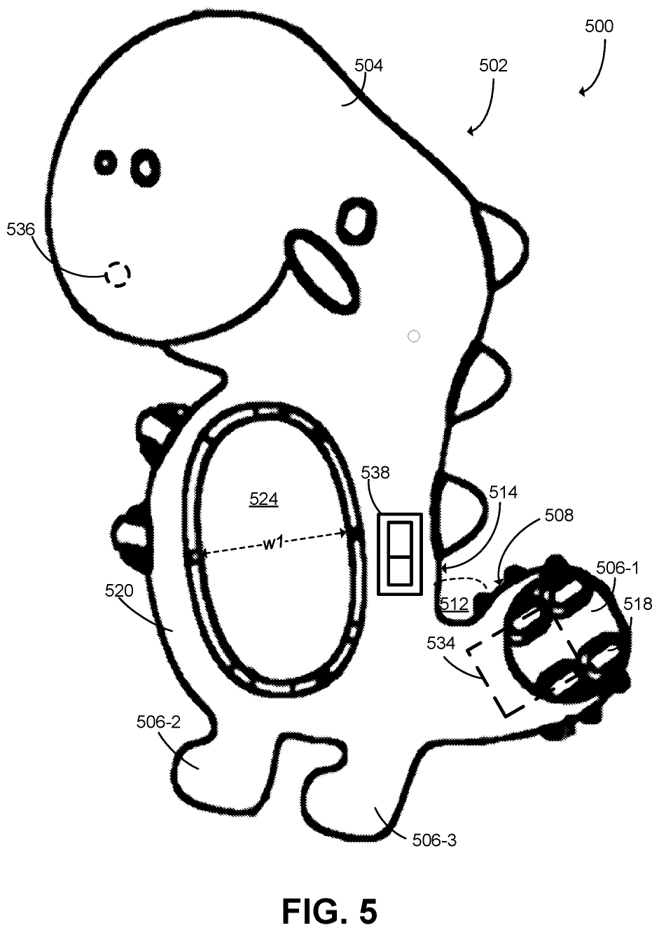

As shown in FIG. 5, in some examples, a system 500 includes a dental care apparatus 502, which may be analogous to apparatuses 102, 202, 302, 402, as described herein. In some examples, the system 500 also includes an electronic component 534 disposed within a protruding member 506. In some examples, the electronic component 534 is configured to vibrate and/or to cause the protruding member 106 to vibrate. In some examples, the system 500 includes one or more light sources 536 that are configured to emit light and are disposed within one of the protruding members 506 and/or the body 504. In some examples, the body 504 includes a switch 538 configured to control the electronic component 534 and/or the light sources 536. In some examples, the electronic component 534 also includes a speaker and is configured to emit sounds, such as music or sounds relating to an animal which the apparatus 502 is shaped to resemble.

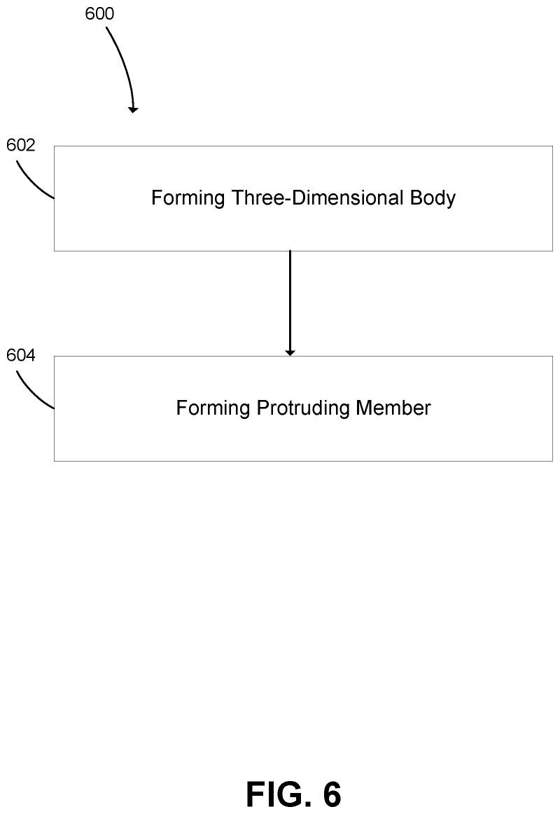

FIG. 6 includes a flow chart illustrating a method 600 of manufacturing a dental care apparatus (e.g., apparatuses 100, 200, 300, 400, 500 described herein). The method 600 forming 602 a three-dimensional body 104 comprised of a substantially robust and flexible material. The method 600 also includes forming 604 at least one protruding member extending from the three-dimensional body 104 and configured to act as a bite block when inserted into a user's mouth. In some examples, a width of the at least one protruding member is different than a thickness of the at least one protruding member 106 such that the at least one protruding member 106 props the user's 150 mouth 152 open at different positions when used as a bite block.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. An apparatus, comprising:
a three-dimensional body, the three-dimensional body comprised of a substantially robust and flexible material; and
at least one protruding member extending from the three-dimensional body, the at least one protruding member configured to act as a bite block when inserted into a user's mouth, wherein a width of the at least one protruding member is different than a thickness of the at least one protruding member such that the at least one protruding member props the user's mouth open at different positions when used as a bite block.

2. The apparatus of claim 1, wherein the body further comprises a first surface, wherein the at least one protruding member is configured to extend at least partially into the user's mouth when the first surface contacts an exterior of the user's mouth.

3. The apparatus of claim 2, wherein the body further comprises a second surface that extends from the first surface at an angle not greater than 90 degrees.

4. The apparatus of claim 3, wherein the second surface is configured to contact an interior of the user's cheek when the first surface contacts an exterior of the user's cheek.

5. The apparatus of claim 1, wherein the at least one protruding member has a minimum dimension of not greater than five centimeters and has a maximum dimension different from the minimum dimension.

6. The apparatus of claim 5, wherein the maximum dimension is not less than 1.5 centimeters.

7. The apparatus of claim 1, further comprising an additional protruding member extending from the three-dimensional body, the additional protruding member configured to act as a bite block when inserted into the user's mouth, being at least partially curved or bent, and having at least one of:
a minimum dimension different from a minimum dimension of the at least one protruding member and not greater than five centimeters; and
a maximum dimension different from a maximum dimension of the at least one protruding member.

8. The apparatus of claim 1, wherein at least one of the three-dimensional body and the at least one protruding member comprises at least one surface protrusion.

9. The apparatus of claim 1, wherein the material has a Shore A hardness of not greater than 80.

10. The apparatus of claim 1, wherein the apparatus is shaped to visually resemble an animal or a person and the at least one protruding member is shaped to resemble an appendage of the animal or person.

11. The apparatus of claim 1, wherein the three-dimensional body further comprises an aperture useable for gripping the apparatus, the aperture having a width greater than or equal to one centimeter.

12. The apparatus of claim 1, wherein:
a surface area of the three-dimensional body is greater than a surface area of the at least one protruding member; and
the three-dimensional body has a thickness that is less than a maximum dimension of the at least one protruding member.

13. The apparatus of claim 1, wherein the material is configured to maintain its shape in response to exposure to a pressure level of up to at least three pounds per square inch and/or in response to exposure to a temperature of up to at least 50 degrees Celsius.

14. The apparatus of claim 13, wherein the material is configured not to permanently deform or fracture in response to exposure to a temperature of 100 degrees Celsius.

15. The apparatus of claim 1, wherein the material is selected from the group comprising silicone, rubber, polyethylene, polypropylene, or any combination thereof.

16. The apparatus of claim 1, wherein the material comprises food-grade silicone.

17. The apparatus of claim 1, wherein the three-dimensional body further comprises a channel configured to receive at least a portion of a finger of a user, wherein the channel does not intersect or extend into the protruding member.

18. A system, comprising:
a three-dimensional body, the three-dimensional body comprised of a substantially robust and flexible material;
at least one protruding member extending from the three-dimensional body, the at least one protruding member configured to act as a bite block when inserted into a user's mouth, wherein a width of the at least one protruding member is different than a thickness of the at least one protruding member such that the protruding member props the user's mouth open at different positions when used as a bite block; and
an electronic component disposed within the protruding member and configured to cause the protruding member to vibrate.

19. The system of claim 18, further comprising one or more lights disposed within at least one of the body and the at least one protruding member.

20. A method, comprising:
forming a three-dimensional body comprised of a substantially robust and flexible material; and
forming at least one protruding member extending from the three-dimensional body and configured to act as a bite block when inserted into a user's mouth, wherein a width of the at least one protruding member is different than a thickness of the at least one protruding member such that the at least one protruding member props the user's mouth open at different positions when used as a bite block.
